(19) United States
(12) Patent Application Publication
(10) Pub. No.: US 2025/0001836 A1
(43) Pub. Date: Jan. 2, 2025

(54) ELECTROMOTIVE REFRIGERANT COMPRESSOR, METHOD FOR OPERATION THEREOF, AIR-CONDITIONING INSTALLATION, COMPUTER PROGRAM PRODUCT AND COMPUTER-READABLE MEDIUM

(71) Applicant: Brose Fahrzeugteile SE & Co. Kommanditgesellschaft, Würzburg, Würzburg (DE)

(72) Inventors: Benedikt DREMEL, Stegaurach (DE); Marco DENK, Memmelsdorf (DE); Mirko NITTMANN, Auerbach (DE)

(21) Appl. No.: 18/822,711

(22) Filed: Sep. 3, 2024

Related U.S. Application Data
(63) Continuation of application No. PCT/EP2023/055245, filed on Mar. 1, 2023.

(30) Foreign Application Priority Data
Mar. 2, 2022 (DE) 10 2022 202 147.9

(51) Int. Cl. B60H 1/32

(52) U.S. Cl. CPC B60H 1/3205; B60H 1/3225; B60H 2001/325; B60H 2001/3272; B60H 2001/3292

(57) ABSTRACT

A method for operating an electromotive refrigerant compressor having an electric motor, includes operating the electric motor using a supply voltage from a second on-board electrical system. The electric motor is operated in an emergency mode if a fault in a low-voltage supply from a first on-board electrical system and/or a fault in a bus for transmitting a control signal, in particular for a desired rotation speed of the electric motor, to the electromotive refrigerant compressor, are/is detected. An electromotive refrigerant compressor, an air-conditioning installation including such an electromotive refrigerant compressor, a computer program product and a computer-readable medium, are also provided.

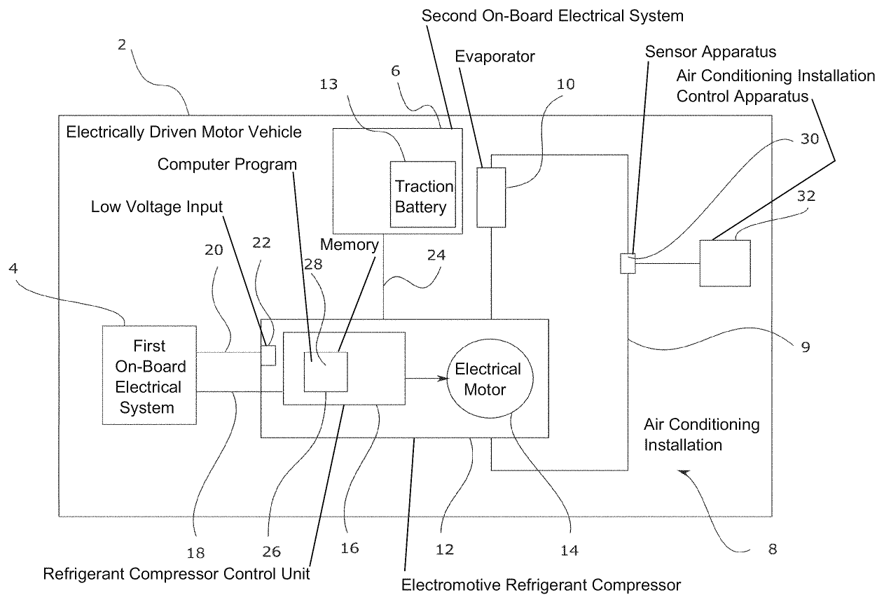

### CROSS-REFERENCE TO RELATED APPLICATION

This application is a continuation, under 35 U.S.C. § 120, of copending International Patent Application PCT/EP2023/055245, filed Mar. 1, 2023, which designated the United States; this application also claims the priority, under 35 U.S.C. § 119, of German Patent Application DE 10 2022 202 147.9, filed Mar. 2, 2022; the prior applications are herewith incorporated by reference in their entirety.

### FIELD AND BACKGROUND OF THE INVENTION

The invention relates to a method for operating an electromotive refrigerant compressor, to such an electromotive refrigerant compressor, to an air-conditioning installation having such an electromotive refrigerant compressor, to a computer program product and to a computer-readable medium.

An electromotive refrigerant compressor for an air-conditioning installation of a motor vehicle, which is in particular electrically driven, includes an electric motor and a control apparatus for the electric motor. A control signal is typically fed to the control apparatus via a bus, in particular a CAN bus or a LIN bus, from a low-voltage on-board electrical system, in particular a 12 V on-board electrical system, wherein the control signal specifies a desired speed (desired motor speed).

Furthermore, the electromotive refrigerant compressor may have a component that is supplied with energy by the low-voltage on-board electrical system. By way of example, the component supplied with power by the low-voltage on-board electrical system is a bus transceiver, in particular the one for transmitting the control signal from the low-voltage on-board electrical system.

The control apparatus of the refrigerant compressor and power electronics, which, for example, are in the form of a bridge circuit or an inverter, for driving the electric motor, are supplied with energy from a second on-board electrical system. In that case, the second on-board electrical system has a voltage that is greater than that of the first on-board electrical system. By way of example, the second on-board electrical system is in the form of a 48 V on-board electrical system or a high-voltage on-board electrical system, in particular a 470 V on-board electrical system or an 800 V on-board electrical system.

In the event of a fault in which bus communication does not work, and therefore in which the control signal is not able to be output to the control apparatus of the refrigerant compressor via the bus, and/or in the event of a fault in which the low voltage from the low-voltage on-board electrical system is not present at the refrigerant compressor, the refrigerant compressor is switched off.

In the event of such a fault, a traction battery of the motor vehicle may disadvantageously not be cooled by using the refrigerant compressor. In particular, if the traction battery is heated due to a charging operation or due to a driving operation, that may result in a breakdown of the motor vehicle.

### SUMMARY OF THE INVENTION

It is accordingly an object of the invention to provide an electromotive refrigerant compressor, a method for operation thereof, an air-conditioning installation, a computer program product and a computer-readable medium, which overcome the hereinafore-mentioned disadvantages of the heretofore-known devices and methods of this general type and through the use of which a breakdown of a motor vehicle having the refrigerant compressor is able to be prevented.

With the foregoing and other objects in view there is provided, in accordance with the invention, a method for operating an electromotive refrigerant compressor that is also referred to as an electrical refrigerant compressor or as a refrigerant compressor for short. The refrigerant compressor includes an electric motor for driving a compressor part, for example a scroll compressor part. In this case, the electric motor is able to be operated by a supply voltage from a second on-board electrical system.

According to the method, the electric motor is (continues to be) operated in an emergency mode if a fault with a low voltage from a first on-board electrical system is recorded. There is such a fault, for example, if no voltage is output from the first on-board electrical system to the refrigerant compressor or this voltage falls below a predefined threshold value. Such a fault is also referred to as “low voltage broken.”

This fault is in particular ascertained by measuring the voltage at a voltage input of the refrigerant compressor for the low voltage from the low-voltage on-board electrical system or by measuring the voltage at a component of the refrigerant compressor that is operated by using the low voltage. By way of example, this component is a bus transceiver, in particular the one for transmitting a control signal from the low-voltage on-board electrical system.

Furthermore, the electric motor continues to be operated in the emergency mode if, additionally or alternatively to the fault with the low voltage, a fault with a bus for transmitting the or a control signal, in particular for a desired speed of the electric motor, to the electromotive refrigerant compressor is recorded. Such a fault is also referred to as “bus broken.” In this case, in particular, no control signals are able to be transmitted from the first on-board electrical system to a control apparatus (control unit) of the electromotive refrigerant compressor.

By way of example, the bus broken may be determined or recorded by a control apparatus of the refrigerant compressor by virtue of a control signal no longer being received and/or a communication interface of the electromotive refrigerant compressor, in particular for communicating with components of the 12 V on-board electrical system, providing a fault signal.

In the emergency mode, the electric motor is operated at a speed that is at least temporarily, in other words at least in a time period, in yet other words at least momentarily, greater than 0 (zero). In particular, the speed is predefined and/or set by the control apparatus of the refrigerant compressor in this case.

In this case, the second on-board electrical system is in particular a 48 V on-board electrical system or a high-voltage on-board electrical system, that is to say an on-board electrical system with a DC voltage of greater than or equal to 60 V, in particular a 470 V on-board electrical system or an 800 V on-board electrical system. In any case, the voltage of the second on-board electrical system is greater than that of the first on-board electrical system.

This advantageously allows the refrigerant compressor to continue to be operated even in the event of one of the faults presented above. In association with this, it is advantageously possible for an air-conditioning installation, which has a refrigerant compressor operated in such a way, of an electrically driven motor vehicle to be able to cool a traction battery, with the result that a breakdown of the motor vehicle is prevented or a risk thereof is at least reduced.

The dependent claims relate to advantageous configurations and developments. In this case, the explanations in connection with the method also apply analogously to the electromotive refrigerant compressor, to the air-conditioning installation, to the computer program product and to the computer-readable medium, and vice versa.

According to one suitable configuration of the method, in the emergency mode, the electric motor is operated at an, in particular constant, motor speed that corresponds to the maximum motor speed of the electric motor. A maximum cooling power is accordingly achieved in this way.

Alternatively, the electric motor is operated at a speed that corresponds to 0.25 times the maximum motor speed, 0.5 times the maximum motor speed, or 0.75 times the maximum motor speed. This allows a minimum level of cooling to be provided in particular for the traction battery of a motor vehicle having the refrigerant compressor and a corresponding air-conditioning installation.

According to an alternative configuration of the method, in the emergency mode, the electric motor of the refrigerant compressor is alternately operated, that is to say operated in a pulsed manner, at a starting speed and not driven, in particular switched off. In other words, an operation of the electric motor at the starting speed and an operation in which the electric motor (and, associated therewith, the compressor part) is not actively driven alternate (in time). For the operation in which the electric motor is not driven, the electric motor is not energized so as to drive its rotor, for example.

The speed of the electric motor therefore alternates between the starting speed, which is in particular predefined by the control apparatus of the refrigerant compressor and/or constant, and a speed that is reduced in relation thereto, for example zero (0). The (running) time for the operation of the electric motor at the starting speed is, for example, 1 second, 10 seconds, 30 seconds or 60 seconds, and the (idle) time for the non-driven operation of the electric motor is, for example, 1 second, 10 seconds, 30 seconds or 60 seconds.

By way of example, the starting speed corresponds to the maximum motor speed, 0.25 times the maximum motor speed, 0.5 times the maximum motor speed, or 0.75 times the maximum motor speed.

Such alternating operation of the electric motor produces a corresponding time profile of the pressure and the flow of a refrigerant processed and/or conveyed using the refrigerant compressor. If such a time profile is recorded using an appropriate sensor, it is therefore possible, as part of a fault diagnosis in the workshop, for example, to infer a functionality of the electromotive refrigerant compressor even if there is a low voltage broken and/or a bus broken present.

With the objects of the invention in view, there is also provided a further aspect of the invention which relates to an electromotive refrigerant compressor having a (refrigerant compressor) control apparatus that is provided and configured to carry out the method in one of the variants presented above. In particular, the electric motor is at least temporarily operated at a speed greater than zero using the (refrigerant compressor) control apparatus if a bus broken and/or a low voltage broken are/is recorded.

With the objects of the invention in view, there is furthermore provided a further aspect of the invention which relates to a computer program product including commands that cause the electromotive refrigerant compressor to carry out the method steps of the method in one of the variants presented above.

With the objects of the invention in view, there is additionally provided a computer-readable medium on which the computer program product is stored. By way of example, the computer-readable medium is an, in particular non-volatile, memory of the control apparatus of the refrigerant compressor or a (different) data carrier.

With the objects of the invention in view, there is concomitantly provided a further aspect of the invention which relates to an air-conditioning installation, in particular for a motor vehicle, wherein the air-conditioning installation has an electromotive refrigerant compressor that is operated according to the method in one of the method variants presented above, and/or is configured according to one of the embodiments presented above.

According to one advantageous development of the air-conditioning installation, the air-conditioning installation has a pressure sensor and/or a flow (rate) sensor for recording the pressure or the flow rate of a refrigerant of the air-conditioning installation. In this case, the pressure sensor and/or the flow sensor are/is connected to an air-conditioning installation control apparatus for signal and/or data transmission purposes, with the result that the air-conditioning installation control apparatus is able to receive corresponding measurement data from the pressure sensor and/or from the flow (rate) sensor.

Furthermore, the air-conditioning installation control apparatus is provided and configured to evaluate the measurement data provided by the pressure sensor and/or flow sensor with regard to a time profile of the pressure or a time profile of the flow of the refrigerant that is produced due to an alternating speed of the electric motor in the emergency mode.

Expediently, the air-conditioning installation control apparatus is coupled to a superordinate vehicle control apparatus or is a part thereof.

Other features which are considered as characteristic for the invention are set forth in the appended claims.

Although the invention is illustrated and described herein as embodied in an electromotive refrigerant compressor, a method for operation thereof, an air-conditioning installation, a computer program and a computer-readable medium, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of exemplary embodiments when read in connection with the accompanying drawing.

### BRIEF DESCRIPTION OF THE FIGURES

The single figure of the drawing is a block circuit diagram of an electrically driven motor vehicle, which includes an air-conditioning installation having an electromotive refrigerant compressor.

### DETAILED DESCRIPTION OF THE INVENTION

Referring now in detail to the single figure of the drawing, there is seen an electrically driven motor vehicle 2 that includes a first on-board electrical system 4, which is in the form of a low-voltage on-board electrical system, specifically a 12 V on-board electrical system, and a second on-board electrical system 6, which has a higher voltage than the first on-board electrical system 4. By way of example, the second on-board electrical system 6 is in this case in the form of a high-voltage on-board electrical system with a voltage of 470 V or with a voltage of 800 V. The first on-board electrical system 4 and the second on-board electrical system 6 are shown in summarized form in the figure using a respective rectangle.

The motor vehicle 2 has an air-conditioning installation 8. The air-conditioning installation includes a refrigerant line 9, through which a refrigerant flows, an evaporator 10 and an electromotive refrigerant compressor 12. Further parts of the air-conditioning installation 8, for example a pressure regulator or a condenser, are not shown in any more detail in the figure.

In this case, by way of example, a traction battery 13 of the motor vehicle 2 that is connected into the second on-board electrical system 6 is able to be cooled by the evaporator 10.

The refrigerant compressor 12 includes an electric motor 14 having power electronics and a (refrigerant compressor) control unit 16 for controlling or regulating the electric motor 14.

The refrigerant compressor control unit 16 is (during normal operation) connected to the first on-board electrical system, in particular to a control apparatus thereof, for example a vehicle control apparatus, for signal transmission purposes. This makes it possible to transmit a control signal to the refrigerant compressor control unit 16 using a bus 18, wherein a desired speed for the electric motor 14 is predefined on the basis of the control signal. Furthermore, the refrigerant compressor 12 is connected to the first on-board electrical system 4 by a supply line 20. The low voltage is therefore present at a low-voltage input 22 during normal operation.

The refrigerant compressor control unit 16 and the electric motor 14, in particular the power electronics thereof, are furthermore able to be supplied with power by the second on-board electrical system 6. The (supply) voltage from the second on-board electrical system 6 is therefore fed to the refrigerant compressor by a further supply line 24.

In the event of a fault (low voltage broken) in which low voltage is not provided by the first on-board electrical system 4, and therefore in which there is no voltage present at the low-voltage input 22, and/or in the event of a fault (bus broken) in which are fed to the refrigerant compressor control unit 16, in particular from the first on-board electrical system 4, the electromotive refrigerant compressor 12 is operated in an emergency mode. In this case, the electric motor 14 is operated at a speed that is at least temporarily greater than 0 (zero). The desired speed is then predefined and/or set by the refrigerant compressor control apparatus 16 in the emergency mode.

In summary, the electromotive refrigerant compressor 12 continues to be operated in the emergency mode if a bus broken and/or a low voltage broken are/is recorded.

The refrigerant compressor control apparatus 16 includes a memory 26 in the form of a computer-readable medium on which a computer program 28 is stored. The computer program includes commands that, upon recording a bus broken and/or a low voltage broken, cause the refrigerant compressor control apparatus 16 to operate the electric motor 14 in an emergency mode in which the speed of the electric motor is at least temporarily greater than zero. In order to record these faults, the commands of the computer program cause, for example, a fault signal from a communication interface between the refrigerant compressor control apparatus 16 and the bus 18 to be evaluated and, if necessary, the emergency mode to be started, a bus broken to be deemed to be recorded and the emergency mode to be started following no control signal being received from the first on-board electrical system 4 for a predefined period of time, and/or the low voltage present at the low-voltage input 22 to be evaluated and the emergency mode to be started if a predefined threshold value is fallen below.

In the emergency mode, a speed of the electric motor 14 is set to be constant, wherein the speed corresponds to a maximum motor speed that is expediently stored in the memory 26 of the refrigerant compressor control apparatus 16. Alternatively, the electric motor 14 is operated at a constant speed that corresponds to 0.25 times the maximum motor speed, 0.5 times the maximum motor speed, or 0.75 times the maximum motor speed. The air-conditioning installation 8 continues to be operated and the traction battery 13 continues to be able to be cooled as a result. Accordingly, the computer program 28 contains commands that cause the electric motor to be operated at one of these speeds.

Alternatively, in the emergency mode, the electric motor 14 is alternately operated at a predefined (starting) speed and not driven, in particular switched off. The electric motor 14 is therefore temporarily operated at the starting speed, and the electric motor is temporarily not driven, in particular its rotor is not set in rotation, wherein the non-driven operation and the operation at the starting speed alternate. Accordingly, the computer program 28 contains commands that cause the electric motor to be operated alternately in such a way.

In the case of this alternating operation, the refrigerant is accordingly compressed and/or caused to flow in the refrigerant line 9. The pressure or the flow rate of the refrigerant or the time profiles thereof are able to be recorded in this case by using a pressure sensor or using a flow sensor. The figure shows, in summarized form, a sensor apparatus 30 that includes the pressure sensor and/or the flow sensor.

The sensor apparatus 30 is connected to an air-conditioning installation control apparatus 32 for signal and/or data transmission purposes, with the result that measurement data from the sensor apparatus are able to be fed to the air-conditioning installation control apparatus 32. The air-conditioning installation control apparatus 32 is provided and configured to evaluate the measurement data, which are fed by the sensor apparatus 30 thereto, with regard to a time profile of the pressure or a time profile of the flow of the refrigerant that is produced due to the alternating operation of the electric motor in the emergency mode.

Expediently, the air-conditioning installation control apparatus 32 is, in a manner not shown in any more detail, coupled to the or a superordinate vehicle control apparatus, in particular the vehicle control apparatus, or is a part thereof. As part of a maintenance operation or repair of the motor vehicle 2, the functionality of the electromotive refrigerant compressor 12 is able to be established in this way even in the event of a bus broken and/or in the event of a low voltage broken.

The invention is not restricted to the exemplary embodiments described above. Rather, other variants of the invention may also be derived therefrom by a person skilled in the art without departing from the subject matter of the invention. In particular, all individual features described in connection with the exemplary embodiments are also able to be combined with one another in another manner without departing from the subject matter of the invention.

The following is a summary list of reference numerals and the corresponding structure used in the above description of the invention:
2 Motor vehicle
4 First on-board electrical system
6 Second on-board electrical system
8 Air-conditioning installation
9 Refrigerant line
10 Evaporator
12 Electromotive refrigerant compressor
13 Traction battery
14 Electric motor
16 Refrigerant compressor control apparatus
18 Bus
20 Supply line
22 Low-voltage input
24 Supply line
26 Memory/Computer-readable medium
28 Computer program
30 Sensor apparatus
32 Air-conditioning installation control apparatus

1. A method for operating an electromotive refrigerant compressor having an electric motor configured to be operated by a supply voltage from a second on-board electrical system, the method comprising:
operating the electric motor in an emergency mode upon recording at least one of a fault with a low voltage from a first on-board electrical system or a fault with a bus for transmitting a control signal to the electromotive refrigerant compressor; and
at least temporarily operating the electric motor at a speed greater than zero in the emergency mode.

2. The method according to claim 1, which further comprises operating the electric motor in the emergency mode at a motor speed corresponding to a maximum motor speed.

3. The method according to claim 1, which further comprises operating the electric motor in the emergency mode at a motor speed corresponding to 0.25 times a maximum motor speed.

4. The method according to claim 1, which further comprises operating the electric motor in the emergency mode at a motor speed corresponding to 0.5 times a maximum motor speed.

5. The method according to claim 1, which further comprises operating the electric motor in the emergency mode at a motor speed corresponding to 0.75 times a maximum motor speed.

6. The method according to claim 1, which further comprises, in the emergency mode, alternately operating the electric motor at a starting speed and not driving the electric motor.

7. An electromotive refrigerant compressor, comprising a refrigerant compressor control apparatus configured to carry out the method according to claim 1.

8. An air-conditioning installation, in particular for a motor vehicle, comprising an electromotive refrigerant compressor at least one of configured to carry out the method or operating according to the method of claim 1.

9. The air-conditioning installation according to claim 8, wherein the air-conditioning installation is an air-conditioning installation for a motor vehicle.

10. The air-conditioning installation according to claim 8, which further comprises:
at least one of a pressure sensor or a flow sensor for recording a pressure or a flow of a refrigerant; and
an air-conditioning installation control apparatus connected to at least one of the pressure sensor or the flow sensor for at least one of signal or data transmission purposes;
the air-conditioning installation control apparatus being provided and configured to evaluate measurement data provided by at least one of the pressure sensor or the flow sensor regarding a time profile of the pressure or a time profile of the flow of the refrigerant produced due to an alternating speed of the electric motor in the emergency mode.

11. A non-transitory computer program product, comprising commands causing the electromotive refrigerant compressor according to claim 7 to carry out the method.

12. A computer-readable medium on which the computer program product according to claim 11 is stored.
